(19) United States
(12) Patent Application Publication
(10) Pub. No.: US 2022/0051055 A1
(43) Pub. Date: Feb. 17, 2022

(54) TRAINING DATA GENERATION METHOD AND TRAINING DATA GENERATION DEVICE

(71) Applicant: Panasonic Intellectual Property Management Co., Ltd., Osaka (JP)

(72) Inventor: Shogo SAKUMA, Osaka (JP)

(73) Assignee: Panasonic Intellectual Property Management Co., Ltd., Osaka (JP)

(21) Appl. No.: 17/512,012

(22) Filed: Oct. 27, 2021

Related U.S. Application Data
(63) Continuation of application No. PCT/JP2021/000980, filed on Jan. 14, 2021.

(30) Foreign Application Priority Data
Mar. 26, 2020 (JP) 2020-056123

(51) Int. Cl. G06K 9/62; G06T 7/70; G06T 7/60; G06K 9/34; G06K 9/20

(52) U.S. Cl. CPC G06K 9/6256; G06T 7/70; G06T 7/60; G06K 9/6288; G06K 9/00812; G06K 9/2054; G06T 2207/20212; G06T 2207/20081; G06K 2209/23; G06K 9/342

(57) ABSTRACT

A training data generation method includes: obtaining a camera image, a labeled image generated by adding annotation information to the camera image, and an object image showing an object to be detected by a learning model; identifying a specific region corresponding to the object based on the labeled image; and compositing the object image in the specific region on each of the camera image and the annotated image.

### CROSS REFERENCE TO RELATED APPLICATIONS

This is a continuation application of PCT International Application No. PCT/JP2021/000980 filed on Jan. 14, 2021, designating the United States of America, which is based on and claims priority of Japanese Patent Application No. 2020-056123 filed on Mar. 26, 2020.

### FIELD

The present disclosure relates to a training data generation method and a training data generation device.

### BACKGROUND

In recent years, object detection devices have been developed which detect objects using learning models trained by machine learning such as deep learning. In order to improve the accuracy in the object detection using a learning model, a large amount of training data is required for the training. In particular, in deep learning, the amount of training data often leads to improvement in the accuracy.

In view of this, various techniques are suggested which increase the amount of data by converting existing training data.

Patent Literature (PTL) 1 discloses cutting a certain region out of one of two images and compositing the cut region onto the other image. On the other hand, PTL 2 discloses cutting a part to be detected on an image of an inspection object and compositing the cut part onto another image of the inspection object.

### CITATION LIST

### Patent Literature

PTL 1: Japanese Unexamined Patent Application Publication No. 2017-45441

PTL 2: Japanese Patent No. 6573226

### SUMMARY

However, the training data generation methods described in the above-described PTL 1 and PTL 2 can be improved upon.

In view of this, the present disclosure relates to a training data generation method and a training data generation device capable of improving upon the related art, in the generation of training data.

A training data generation method according to an aspect of the present disclosure includes: obtaining a camera image, an annotated image generated by adding annotation information to the camera image, and an object image showing an object to be detected by a learning model; identifying a specific region corresponding to the object based on the annotated image; and compositing the object image in the specific region on each of the camera image and the annotated image.

A training data generation device according to an aspect of the present disclosure includes: an obtainer that obtains a camera image, an annotated image generated by adding annotation information to the camera image, and an object image showing an object to be detected by a learning model; a label determiner that identifies a specific region corresponding to the object based on the annotated image; and an image compositor that composites the object image in the specific region on each of the camera image and the annotated image.

The training data generation method, for example, according to an aspect of the present disclosure is capable of improving upon the related art, in the generation of training data.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram showing a functional configuration of an image generation device according to Embodiment 1.

FIG. 2A shows example camera images stored in a first storage according to Embodiment 1.

FIG. 2B shows example labeled images stored in the first storage according to Embodiment 1.

FIG. 2C shows an example object image stored in the first storage according to Embodiment 1.

FIG. 3A shows example composite camera images to be stored in a second storage according to Embodiment 1.

FIG. 3B shows example composite labeled images to be stored in the second storage according to Embodiment 1.

FIG. 4 is a flowchart showing an operation of the image generation device according to Embodiment 1.

FIG. 5 is a flowchart showing an example operation in the processing of compositing an object image according to Embodiment 1.

FIG. 6 shows a result of calculating the center coordinates of target labels according to Embodiment 1.

FIG. 7 shows a result of calculating the orientations of the target labels according to Embodiment 1.

FIG. 8 is a block diagram showing a functional configuration of an image generation device according to Embodiment 2.

FIG. 9A shows composite camera images to be stored in a second storage according to Embodiment 2.

FIG. 9B shows composite labeled images to be stored in the second storage according to Embodiment 2.

FIG. 10 is a flowchart showing an operation in the processing of compositing an object image according to Embodiment 2.

### DESCRIPTION OF EMBODIMENTS

### (Underlying Knowledge Forming the Basis of the Present Disclosure)

As described in Summary, the training data generation methods described in the above-described PTL 1and PTL 2 can be improved upon. An example is that the technique according to PTL 1 may generate an image of an actually impossible scene such as a vehicle floating in the sky. Using training data including such an image, the accuracy of the learning model may deteriorate. Another example is that the technique according to PTL 2 calculates the position at which the cut portion is to be composited onto the other image of the inspection object, based on statistical information.

That is, the technique according to PTL 2 requires information other than the training data, and is thus inapplicable unless such information has been obtained in advance.

A training data generation method according to an aspect of the present disclosure includes: obtaining a camera image, an annotated image generated by adding annotation information to the camera image, and an object image showing an object to be detected by a learning model; identifying a specific region corresponding to the object based on the annotated image; and compositing the object image in the specific region on each of the camera image and the annotated image. For example, in the training data generation method, the compositing includes compositing the object image in the specific region on the camera image and compositing the annotation information corresponding to the object image in the specific region on the annotated image.

Accordingly, the region in which the object image is to be composited can be determined based on the annotated image. That is, the position at which the object image is to be composited can be determined without using any information other than the training data. This reduces the generation of images of actually impossible scenes such as a vehicle floating in the sky. As a result, the training data is generated which includes images of actually possible scenes without using any information other than the training data.

Note that the training data used for training a learning model includes sets of camera images and annotated images. The camera images are used as input images at the time of training the learning model. The annotated images are used as ground truth data at the time of training the learning model.

For example, the training data generation method may further include: calculating a center coordinate of the specific region based on the annotated image. The object image may be composited to overlap the center coordinate on each of the camera image and the annotated image.

Accordingly, the object image is composited in a position closer to an actually possible position. As a result, the training data is generated which includes images of actually possible scenes.

For example, the training data generation method may further include: calculating an orientation of the specific region based on the annotated image. The object image may be composited in an orientation corresponding to the orientation of the specific region.

Accordingly, the object image is composited in an orientation closer to an actually possible orientation. As a result, the training data is generated which includes images of actually possible scenes.

For example, the training data generation method may further include: obtaining a size of the specific region based on the annotated image. The object image may be scaled to a size smaller than or equal to the size of the specific region, and is composited.

Accordingly, the object image is composited in a size closer to an actually possible size. As a result, the training data is generated which includes images of actually possible scenes.

For example, the training data generation method may further include: calculating a total number of specific regions corresponding to the object based on the annotated image, the specific regions each being the specific region; calculating combinations of compositing the object image in one or more of the specific regions; and compositing the object image in each of the combinations.

Accordingly, the images of actually possible scenes are increased efficiently. As a result, the training data is efficiently generated which includes images of actually possible scenes. For example, the training data generation method may further include: updating, based on the object image, the annotation information on the specific region on the annotated image on which the object image has been composited.

Accordingly, a change in the attribute of the part of the specific region in which the object image has been composited is reflected on the entire specific region. If the other part of the specific region is small, an annotated image is generated which is suitable for a camera image on which the object image has been composited.

For example, the annotated image may be a labeled image obtained by performing image segmentation of the camera image. The object image may be composited in the specific region on the labeled image.

Accordingly, the costs for generating the training data are more largely reduced than in manual generation of the training data for image segmentation.

A training data generation device according to an aspect of the present disclosure includes: an obtainer that obtains a camera image, an annotated image generated by adding annotation information to the camera image, and an object image showing an object to be detected by a learning model; a label determiner that identifies a specific region corresponding to the object based on the annotated image; and an image compositor that composites the object image in the specific region on each of the camera image and the annotated image.

These provide the same advantages as the training data generation method described above.

These general and specific aspects may be implemented using a system, a method, an integrated circuit, a computer program, or a non-transitory computer-readable recording medium such as a CD-ROM, or any combination of systems, methods, integrated circuits, computer programs, or recording media. The programs may be stored in advance in a recoding medium or supplied to the recoding medium via a wide-area communication network including the Internet.

Now, embodiments will be specifically described with reference to the drawings.

Note that the embodiments described below are mere comprehensive or specific examples. The numerical values, shapes, constituent elements, the arrangement and connection of the constituent elements, steps, step orders etc. shown in the following embodiments are thus mere examples, and are not intended to limit the scope of the present disclosure. For example, the numerical values not only represent the exact values but also cover the substantially equal ranges including errors of several percent. Among the constituent elements in the following embodiments, those not recited in any of the independent claims are described as optional constituent elements. The figures are schematic representations and not necessarily drawn strictly to scale. In the figures, substantially the same constituent elements are assigned with the same reference signs.

In this specification, the system not necessarily includes a plurality of devices but may include a single device.

### Embodiment 1

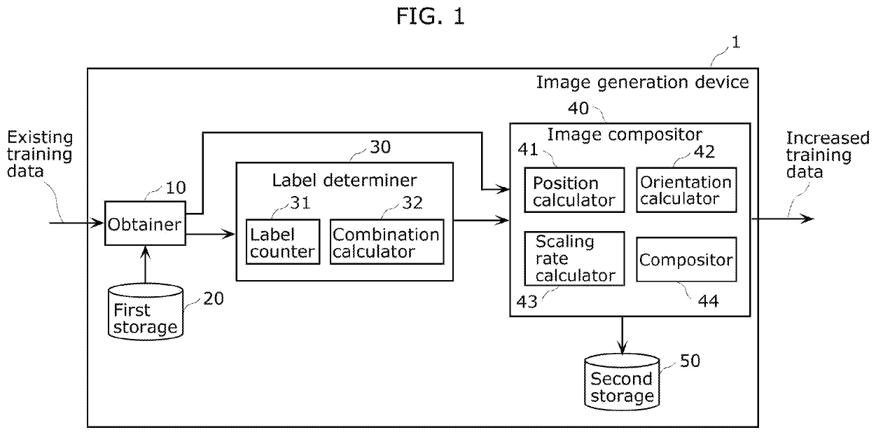

Now, an image generation device according to this embodiment will be described with reference to FIGS. 1 to 3B.

### [1-1. Configuration of Image Generation Device]

First, a configuration of the image generation device according to this embodiment will be described with reference to FIG. 1. FIG. 1 is a block diagram showing a functional configuration of image generation device 1 according to this embodiment. Image generation device 1 according to this embodiment generates training data (data sets) used for machine learning of learning models. Specifically, image generation device 1 performs the processing of automatically increasing the amount of training data (i.e., the number of training data sets) used for machine learning, based on existing training data, for example, and outputs the increased training data.

Now, an example of generating (i.e., increasing) training data by compositing an image of a vehicle in parking spaces in a parking lot will be described. In the following example, the learning model for performing semantic segmentation (i.e., image segmentation) will be described.

As shown in FIG. 1, image generation device 1 includes obtainer 10, first storage 20, label determiner 30, image compositor 40, and second storage 50. Image generation device 1 is an example of the training data generation system.

Obtainer 10 obtains the existing training data to be processed by image generation device 1. For example, obtainer 10 may obtain the existing training data from an external device through communications. In this case, obtainer 10 includes a communication circuit (or a communication module) for communicating with the external device. If first storage 20 stores the existing training data, obtainer 10 may read the existing training data from the first storage 20. The existing training data has been generated or obtained in advance, for example. The existing training data may be published training data (data sets), for example.

First storage 20 is a storage device that stores various information used when image generation device 1 executes the processing of increasing the training data. First storage 20 stores the existing training data to be increased by image generation device 1, and object images showing objects to be detected by learning models. For example, first storage 20 is a semiconductor memory. If obtainer 10 obtains the existing training data from an external device, first storage 20 may not store the existing training data.

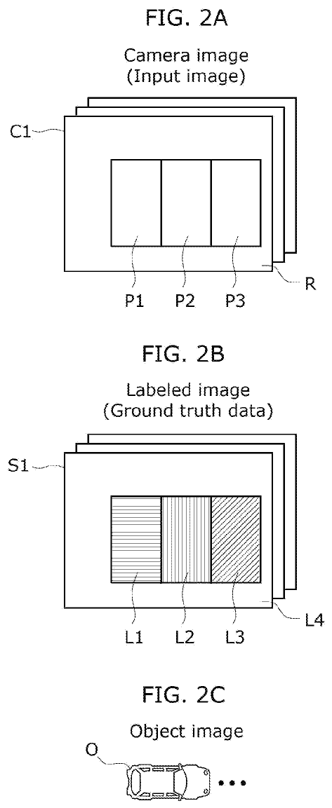

Here, the various information stored in first storage 20 will be described with reference to FIGS. 2A to 2C. FIG. 2A shows an example of camera image C1 stored in first storage 20 according to this embodiment. FIG. 2B shows an example of labeled image S1 stored in first storage 20 according to this embodiment. FIG. 2C shows an example of object image O stored in first storage 20 according to this embodiment. Note that training data includes a plurality of sets of camera images C1 and labeled images Si.

As shown in FIG. 2A, first storage 20 stores a plurality of camera images including camera image C1. Camera image C1 has been captured by an imaging device such as a camera (e.g., an on-vehicle camera). Camera image C1 includes, for example, three parking spaces P1 to P3 and aisle R. Note that camera image C1 is used as an input image at the time of training a learning model.

As shown in FIG. 2B, first storage 20 stores a plurality of labeled images including labeled image S1. Labeled image S1 is in the same size as camera image C1 and provided with label values (e.g., integers). Each label value is given to the pixels considered as the same object region on camera image C1. That is, labeled image S1 has label values as pixel values. Note that labeled image S1 is used as ground truth data at the time of training a learning model. The label values are examples of the annotation information. Labeled image S1 is an example of the annotated image. Labeled region L1 is a region (i.e., a horizontally hatched region) corresponding to parking space P1 on camera image C1 and provided with a first label value indicating that parking is possible. Labeled region L1 on labeled image S1 is located at the same position as parking space P1 on camera image C1. Labeled region L2 is a region (i.e., a vertically hatched region) corresponding to parking space P2 on camera image C1 and provided with a second label value indicating that parking is possible. Labeled region L2 on labeled image S1 is located at the same position as parking space P2 on camera image C1.

Labeled region L3 is a region (i.e., a diagonally hatched region) corresponding to parking space P3 on camera image C1 and provided with a third label value indicating that parking is possible. Labeled region L3 on labeled image S1 is located at the same position as parking space P3 on camera image C1. Labeled region L4 is a region (i.e., a non-hatched region) corresponding to aisle R on camera image C1 and provided with a label value corresponding to an aisle. Labeled region L4 on labeled image S1 is located at the same position as aisle R on camera image C1.

In this manner, in this embodiment, it can also be said that labeled regions L1 to L3 are provided with the label values indicating that parking is possible and that labeled region L4 is provided with the label value indicating that no parking is possible. Note that the first to third label values may be the same or different from each other. Note that the labeled regions will also be simply referred to “labels”.

How to generate labeled image S1 is not particularly limited, and any known method may be used. Labeled image S1 may be generated by manually labeling camera image C1 or automatically generated through image segmentation of camera image C1.

As shown in FIG. 2C, first storage 20 stores a plurality of object images including object image O. In this embodiment, object image O shows a vehicle. Object Image O may be generated by cutting an object region from an image captured by an imaging device, or may be a computer graphic (CG) image. Object image O is composited onto camera image C1 and labeled image S1 by image compositor 40 which will be described later.

Note that the object is not necessarily a vehicle but may be any object corresponding to camera image C1. An object may be a motorcycle, a person, or any other thing.

Referring back to FIG. 1, label determiner 30 determines target labels, onto which object image O is to be composited, on the labeled image S1 based on labeled image S1. Label determiner 30 includes label counter 31 and combination calculator 32.

Label counter 31 counts, out of labeled image S1, the number of labels on labeled image S1. In FIG. 2B, label counter 31 counts three labels (i.e., labeled regions L1 to L3) as parking spaces and one label (i.e., labeled region L4) as an aisle.

Label counter 31 counts the number of labels on which object image O is to be composited on labeled image S1. Label counter 31 counts three parking spaces as target labels on which an object (e.g., a vehicle) shown by object image O is to be composited. For example, label counter 31 may count the number of target labels based on a table including objects that may be shown by object image O and label values corresponding to the objects in association. In this embodiment, labeled regions L1 to L3 corresponding to parking spaces P1 to P3 are examples of the specific regions corresponding to an object shown by object image O. It can also be said that label counter 31 identifies the specific regions corresponding to an object shown by object image O based on labeled image S1.

Combination calculator 32 calculates combinations of the labels on which object image O is to be composited, based on the number of labels counted by label counter 31. In FIG. 2B, combination calculator 32 calculates there are seven combinations of the labels on which object image O is to be composited. That is, combination calculator 32 determines that there are seven combinations of the labels.

The seven combinations are as follows: labeled region L1; labeled region L2; labeled region L3; labeled regions L1 and L2, labeled regions L1 and L3, labeled regions L2 and L3, and labeled regions L1 to L3. In this manner, combination calculator 32 advantageously calculates all the combinations of the labels in view of effectively increasing the training data. Note that combination calculator 32 not necessarily calculates all the combinations of the labels.

Image compositor 40 composites object image O onto camera image C1 based on the combinations of the labels determined by label determiner 30. For example, image compositor 40 composites object image O onto camera image C1 in all the combinations of the labels. Image compositor 40 includes position calculator 41, orientation calculator 42, scaling rate calculator 43, and compositor 44.

Position calculator 41 calculates the coordinates (e.g., pixel coordinates) of the target labels counted by label counter 31 on labeled image S1. Position calculator 41 calculates the center coordinates of the target labels on labeled image S1. Position calculator 41 calculates the center coordinates of the target labels based on the barycentric coordinates of the target labels. Center coordinates are references used for compositing object image O onto the target labels.

For example, position calculator 41 calculates the barycentric coordinates of the regions with a target label (e.g., labeled region L1) as the center coordinate of the labeled region. If the region with a target label is in a rectangular shape, for example, position calculator 41 may calculate the center coordinate of the region with the target label based on the respective coordinates of the four corners forming the target label. Accordingly, the coordinate of the vicinity of the center of the region with the target label can be calculated as the center coordinate, and object image O can thus be composited at an actually possible position in the processing which will be described later.

Position calculator 41 may calculate, as the center coordinate of a target label, a coordinate obtained by moving the barycentric coordinate of the region with the target label within a certain range. For example, position calculator 41 may move the barycentric coordinate of the region with the target label in accordance with the normal distribution within a certain range. Position calculator 41 may move the center position from the center of gravity as long as object image O falls within the region with the target label. Position calculator 41 may calculate a plurality of center coordinates for a single target label.

Note that the center coordinates (e.g., the pixel coordinates) of target labels on labeled image S1 are the same as those of the parking spaces corresponding to the target labels on camera image C1.

Orientation calculator 42 calculates the orientations of the target labels. For example, orientation calculator 42 performs principal component analysis on the distribution of the points (i.e., coordinates) included in the region with a target label on labeled image S1, and calculates the orientation of the target label based on the result of principal component analysis. For example, orientation calculator 42 may calculate the orientation of a target label using the eigenvector obtained as the result of principal component analysis.

Note that orientation calculator 42 may calculate the orientation by another known method. For example, if a label is in a rectangular shape, orientation calculator 42 may calculate the direction of one of longer or shorter sides of the label on labeled image S1. For example, if a label is in an oval shape, orientation calculator 42 may calculate the direction of the longer or shorter axis of the label on labeled image S1. Note that the longer axis is an example of the longer sides, and the shorter axis is an example of the shorter sides.

Scaling rate calculator 43 calculates the scaling rate of object image O based on the size of the region with a target label. Scaling rate calculator 43 calculates scaling rate of object image O to composite object image O in the region with the target label to fall within the region with the target label. For example, scaling rate calculator 43 calculates scaling rate of object image O so that the size of object image O is smaller than or equal to that of the region with the target label. If there is a plurality of target labels, scaling rate calculator 43 calculates the respective scaling rates of the target labels. Scaling rate calculator 43 may calculate one or more scaling rates for a single target label.

Compositor 44 composites object image O onto each of camera image C1 and labeled image S1 based on the center coordinates of the target labels on labeled image S1. For example, compositor 44 superimposes object image O in the center coordinates of the target labels on labeled image S1 and in the positions corresponding to the center coordinates on camera image C1 to composite object image O onto camera image C1 and labeled image S1, respectively. For example, compositor 44 superimposes object image O in the center coordinates of the parking spaces on camera image C1 to composite object image O onto camera image C1. Compositor 44 gives the label value corresponding to object image O to the center coordinates of the labels on labeled image S1 to composite object image O onto labeled image S1. For example, compositor 44 may composite object image O onto camera image C1 so that the center coordinate of object image O overlaps the center coordinate of each parking space on camera image C1. Compositor 44 may composite object image O onto labeled image S1 so that the center coordinate of object image O overlaps the center coordinate of each target label on labeled image S1.

Compositor 44 may composite object image O onto each of camera image C1 and labeled image S1 so that the orientation of each target label calculated by orientation calculator 42 is parallel to the orientation of object image O. For example, compositor 44 may composite object image O onto camera image C1 so that one of the longer or shorter sides of the label is parallel to the one of the longer or shorter sides of object image O. One of the longer or shorter sides of the label is an example of the orientation of the label. For example, compositor 44 composites object image O onto each of camera image C1 and labeled image S1 with the same orientation.

Compositor 44 may change the size of object image O using the scaling rate corresponding to each target label calculated by scaling rate calculator 43 to composite changed object image O onto each of camera image C1 and labeled image S1. Compositor 44 may adjust the size of object image O in accordance with the size of the region with a target label, that is, the size of the parking space to composite adjusted object image O onto camera image C1 and labeled image S1. For example, compositor 44 composites object image O scaled at the same scaling rate onto camera image C1 and labeled image S1.

Note that how compositor 44 composites images is not particularly limited, and any known method may be used. For example, object image O may be composited by chroma key compositing.

Second storage 50 is a storage device that stores camera image C1 and labeled image S1 on which object image O has been composited by image compositor 40. Second storage 50 stores training data (i.e., the increased training data) generated by image generation device 1 performing the processing of increasing the training data. For example, second storage 50 is a semiconductor memory. Note that camera image C1 on which object image O has been composited may also be referred to as a “composite camera image” and labeled image S1 on which object image O has been composited as a “composite labeled image”.

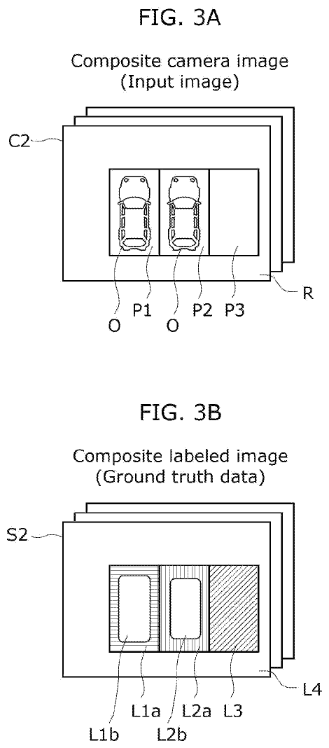

Here, the training data to be stored in second storage 50 will be described with reference to FIGS. 3A and 3B. FIG. 3A shows an example of composite camera image C2 to be stored in second storage 50 according to this embodiment. FIG. 3B shows an example of composite labeled image S2 to be stored in second storage 50 according to this embodiment.

As shown in FIG. 3A, second storage 50 stores a plurality of composite camera images including composite camera image C2. Composite camera image C2 is an image obtained by compositing object image O in each of parking spaces P1 and P2 on camera image C1 and an increased image. Composite camera image C2 is used as an input image at the time of training a learning model.

As shown in FIG. 3B, second storage 50 stores a plurality of composite labeled images including composite labeled image S2. Composite labeled image S2 is an image obtained by compositing object image O in each of labeled regions L1 and L2 on labeled image S1 and an increased image. Composite labeled image S2 is used as ground truth data at the time of training a learning model.

Labeled region L1b corresponds to object image O composited in parking space P1 on composite camera image C2 and is provided with the label value corresponding to object image O. Labeled region L1b on composite labeled image S2 is located at the same position as object image O in parking space P1 on composite camera image C2.

Labeled region L2b corresponds to object image O composited in parking space P2 on composite camera image C2 and is provided with the label value corresponding to object image O. Labeled region L2b on composite labeled image S2 is located at the same position as object image O in parking space P2 on composite camera image C2.

Labeled region L1a is the part of labeled region L1 shown in FIG. 2B other than labeled region L1b and provided with a label value indicating that parking is possible. Labeled region L2a is the part of labeled region L2 shown in FIG. 2B other than labeled region L2b and provided with a label value indicating that parking is possible.

Labeled regions L1a and L2a are provided with the label values indicating that parking is possible, whereas labeled regions L1b and L2b provided with the label values indicating that no parking is possible. Labeled regions L1b and L2b may be provided with the same label value as labeled region L4. In this manner, in this embodiment, on composite labeled image S2, the label values of only the parts of the regions with the target labels on which object image O has been composited are updated. Accordingly, the following training data is generated. For example, assume that a plurality of vehicles can be parked in a parking space and one vehicle is parked in the parking space. In this case, the training data allows detection of the remaining region for parking another vehicle.

As described above, image generation device 1 identifies regions (e.g., parking spaces) corresponding to object image O based on labeled image S1, and composites object image O in the identified regions on each of camera image C1 and labeled image S1.

### [1-2. Operation of Image Generation Device]

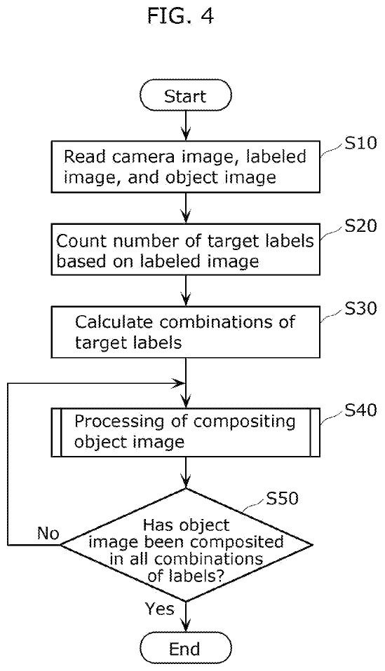

Now, an operation of image generation device 1 according to this embodiment will be described with reference to FIGS. 4 to 7. FIG. 4 is a flowchart showing the operation of image generation device 1 according to this embodiment.

As shown in FIG. 4, if first storage 20 stores various information, obtainer 10 reads and obtains camera image C1, labeled image S1, and object image O from first storage 20 (S10). Obtainer 10 outputs obtained labeled image S1 to label determiner 30, and camera image C1, labeled image S1, and object image O to image compositor 40. Object image O may be, for example, determined in accordance with the label on which object image O is to be composited or set in advance by a user. Note that a plurality of types of object images O may be obtained. For example, in the case of vehicles, a plurality of types of object images O may be obtained which are different in at least one of the outer shape, color, or size.

Next, label counter 31 of label determiner 30 counts the number of target labels for composition based on labeled image S1 (S20). For example, label counter 31 counts, as target labels, the labels corresponding to an object (e.g., a vehicle) shown by object image O out of a plurality of labels included in labeled image S1. On labeled image S1 shown in FIG. 2B, label determiner 30 counts, as target labels, labeled regions L1 to L3 indicating parking spaces P1 to

P3 corresponding to vehicles out of labeled regions L1 to L4. On labeled image S1, there are three target labels.

Next, combination calculator 32 calculates combinations of the target labels (S30). Based on the target labels, combination calculator 32 calculates combinations of the labels on which object image O is to be composited. For example, combination calculator 32 advantageously calculates all the combinations of the labels on which object image O is to be composited. In the example of FIG. 2B, there are seven combinations in total. Combination calculator 32 outputs the calculated combinations to image compositor 40.

Next, image compositor 40 performs the processing of compositing object image O based on camera image C1, labeled image S1, object image O, and the combinations of the labels (S40). If the target label is labeled region L1, image compositor 40 composites object image O in parking space P1 corresponding to labeled region L1 on camera image C1. In addition, image compositor 40 composites the label value indicating object image O in labeled region L1 on labeled image S1. The details of step S40 will be described later. Note that compositing the label value indicating object image O in labeled region L1 is an example of compositing object image O in labeled region L1.

Next, image compositor 40 determines whether object image O has been composited in all the combinations of the labels (S50). Image compositor 40 determines whether object image O has been composited in all the combinations of the target labels calculated by combination calculator 32. In the example of FIG. 2B, image compositor 40 determines whether object image O has been composited in all the seven combinations.

If object image O has been composited in all the combinations of the labels (Yes in S50), image compositor 40 ends the processing of generating (i.e., increasing) the training data. Image compositor 40 may output the generated training data to an external device. If object image O has not been composited in all the combinations of the labels (No in S50), image compositor 40 performs the processing of compositing object image O in the rest of the combinations of the labels.

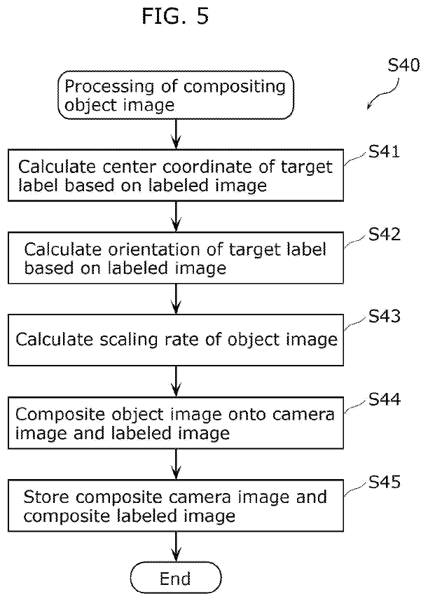

Here, the processing of compositing object image O will be described with reference to FIGS. 5 to 7. FIG. 5 is a flowchart showing an example operation in the processing of compositing object image O according to this embodiment. Note that the processing of compositing object image O in the combination of labeled regions L1 and L2 will now be described out of the seven combinations of the labels.

As shown in FIG. 5, position calculator 41 calculates the center coordinates of target labels based on labeled image S1 (S41). For example, position calculator 41 calculates, as the center coordinates, the barycentric coordinates of the regions with the target labels (e.g., labeled region L1) from labeled image S1.

Position calculator 41 calculates the respective center coordinates of the target labels counted by label counter 31. Position calculator 41 outputs the calculated center coordinates of the target labels to compositor 44.

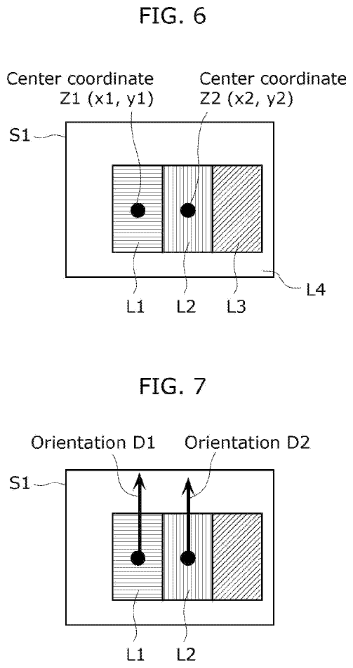

Here, the center coordinates of the target labels calculated by position calculator 41 will be described with reference to FIG. 6. FIG. 6 shows a result of calculating the center coordinates of the target labels.

As shown in FIG. 6, position calculator 41 calculates Z1 (x1, y1) as the center coordinate of labeled region L1, and Z2 (x2, y2) as the center coordinate of labeled region L2. Position calculator 41 calculates the respective center coordinates of labeled regions L1 and L2 included in the combination. Having calculated the center coordinate of at least one of labeled regions L1 and L2 in the past, position calculator 41 may read and obtain the center coordinate(s) of the label(s) stored in a storage (e.g., first storage 20).

Next, referring back to FIG. 5, orientation calculator 42 calculates the orientations of the target labels based on labeled image S1 (S42). For example, orientation calculator 42 performs principal component analysis of each target label and calculates the orientation of the target label using the eigenvector. Orientation calculator 42 calculates the orientations of the target labels counted by label counter 31. Orientation calculator 42 outputs the calculated orientations of the target labels to compositor 44.

Here, the orientations of the target labels calculated by orientation calculator 42 will be described with reference to FIG. 7. FIG. 7 shows a result of calculating the orientations of the target labels.

As shown in FIG. 7, orientation calculator 42 calculates D1 as the orientation of labeled region L1, and D2 as the orientation of labeled region L2. Orientation calculator 42 calculates the orientations of labeled regions L1 and L2 included in the combination. Having calculated the orientation of at least one of labeled regions L1 and L2 in the past, orientation calculator 42 may read and obtain the orientation(s) of the label(s) stored in a storage (e.g., first storage 20).

Referring back to FIG. 5, scaling rate calculator 43 calculates the scaling rate of object image O based on the size of labeled region L1 (S43). Scaling rate calculator 43 calculates scaling rate of object image O to composite object image O in the region with a target label to fall within the region with the target label. Scaling rate calculator 43 outputs the scaling rate of object image O to compositor 44.

Compositor 44 composites object image O onto camera image C1 and labeled image S1 (S44). For example, compositor 44 composites object image O in each of parking spaces P1 and P2 on camera image C1. For example, compositor 44 composites object image O at a position within each of parking spaces P1 and P2 on camera image C1. For example, compositor 44 composites object image O at the position where the difference between the center coordinates of parking space P1 and object image O falls within a predetermined range. For example, compositor 44 composites object image O at the position where the center coordinates of parking space P1 and object image O overlap each other. This also applies to the composition of object image O in parking space P2.

If there are a plurality of object images O, same object image O or different object images O may be composited in parking spaces P1 and P2.

In compositing a plurality of object images O onto single camera image C1, compositor 44 may determine the position at which object images O do not overlap each other as the positions at which object images O are to be composited.

For example, compositor 44 composites object image O in each of labeled regions L1 and L2 on labeled image S1. Specifically, for example, compositor 44 composites the label value corresponding to object image O in the regions in the same size as object image O in labeled regions L1 and L2 on labeled image S1. Compositor 44 composites object image O at the following positions on labeled image S1. The positions (i.e., the pixel positions) on camera image C1 onto which object image O has been composited are the same as the positions (i.e., the pixel positions) on labeled image S1 onto which the label value indicating object image O have been composited. Accordingly, the region in which object image O has been composited out of the region (e.g., labeled region L1) with the label value indicating parking space P1 is updated as the label value indicating object image O.

In this manner, compositor 44 composites object image O in a specific region (i.e., parking space P1 in this embodiment) on camera image C1, and the label value corresponding to object image O in a specific region (i.e., labeled region L1 in this embodiment) on labeled image S1. This is an example of the composition of object image O onto camera image C1 and labeled image S1.

Next, image compositor 40 stores composite camera image C2 and composite labeled image S2 obtained by compositor 44 compositing object image O (S45). Specifically, image compositor 40 stores composite camera image C2 and composite labeled image S2 in association in second storage 50. The processing of compositing object image O is performed in each of the combinations of the labels, the plurality of composite camera images shown in FIG. 3A and the plurality of composite labeled image shown in FIG. 3B are generated.

As described above, image generation device 1 determines the position at which object image O is to be composited, based on labeled image S1. This reduces the generation of actually impossible images such as an image of an object floating in the air. In other words, image generation device 1 generates proper training data on actually possible situations, that is, high-quality training data. A learning model trained using such training data is expected to have improved generalization performance and accuracy in the object detection.

As described above, image generation device 1 automatically generates the increased training data based on existing training data. Image generation device 1 automatically determines the positions at which composite object image O is to be composited onto camera image C1 and labeled image S1, based on the label values of labeled image S1. This reduces more costs for generating the training data than manual position determination.

In particular, training data for the semantic segmentation is often manually labeled for each pixel, which increases the costs for generating the training data. Image generation device 1 automatically generates training data for the semantic segmentation using labeled image S1, which largely reduces the costs for generating the training data for the semantic segmentation.

By the method described above, image generation device 1 generates a large amount of training data through composition, even in an unusual case, in which obtainment of a large amount of data in advance is difficult, in specific equipment or a specific scene (e.g., a scene of a parking lot).

### Embodiment 2

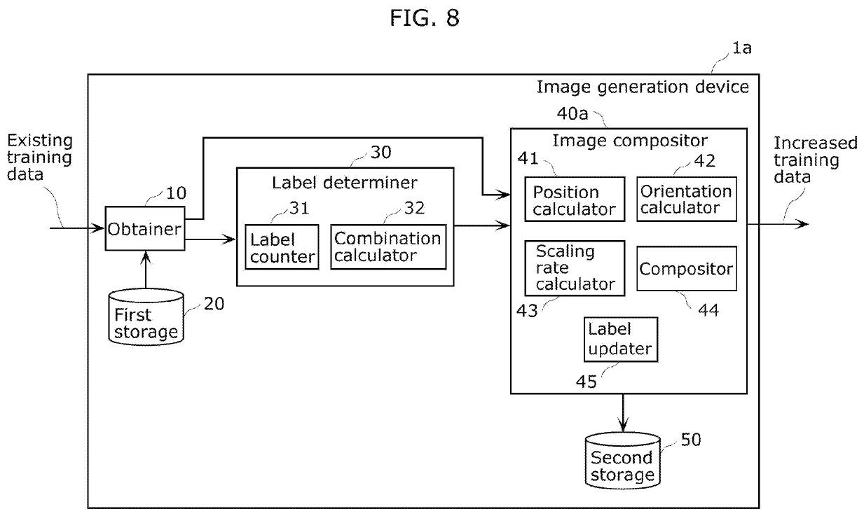

Now, an image generation device according to this embodiment will be described with reference to FIGS. 8 to 10.

### [2-1. Configuration of Image Generation Device]

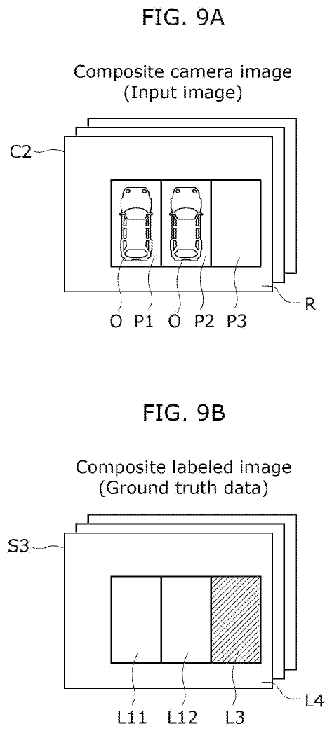

First, a configuration of the image generation device according to this embodiment will be described with reference to FIGS. 8 to 9B. FIG. 8 is a block diagram showing a functional configuration of image generation device 1a according to this embodiment. The same reference signs as those of image generation device 1 according to Embodiment 1 will be used to represent the same or similar elements, and the detailed explanation thereof will be omitted.

As shown in FIG. 8, image generation device 1a according to this embodiment differs from image generation device 1 according to Embodiment 1 in including image compositor 40a in place of image compositor 40. Now, the differences from image generation device 1 will be described mainly.

Image compositor 40a includes label updater 45 in addition to image compositor 40 according to Embodiment 1.

Label updater 45 updates the label values of the regions with the target labels onto which object image O has been composited on composite labeled image S2. Label updater 45 updates all the regions with the target labels onto which object image O has been composited to the label value indicating object image O. For example, assume that compositor 44 has composited object image O in labeled region L1 indicating parking space P1. In this case, label updater 45 updates entire labeled region L1, that is, labeled region L1 (e.g., labeled regions L1b and L2b shown in FIG. 3B), in which object image O is not composited, to the label value indicating object image O.

Image compositor 40a stores, in second storage 50, the composite labeled images in which the label values of the entire regions with the target labels are updated by label updater 45. In addition, image compositor 40a may output composite labeled images to an external device.

Here, the training data stored in second storage 50 will be described with reference to FIGS. 9A and 9B. FIG. 9A shows an example of composite camera image C2 to be stored in second storage 50 according to this embodiment. FIG. 9B shows an example of composite labeled image S3 to be stored in second storage 50 according to this embodiment. Note that composite camera image C2 shown in FIG. 9A is the same as composite camera image C2 in Embodiment 1, and the description will thus be omitted.

As shown in FIG. 9B, second storage 50 stores a plurality of composite labeled images including composite labeled image S3. On composite labeled image S3, entire labeled regions L11 and L12 on labeled image S1 are updated to the label values indicating object image O. Composite labeled image S3 is used as ground truth data at the time of training a learning model.

Labeled region L11 corresponds to parking space P1 on camera image C1 and is provided with the label value indicating object image O. Labeled region L11 on composite labeled image S3 is located at the same position as parking space P1 on camera image C1.

Labeled region L12 corresponds to parking space P2 on camera image C1 and is provided with the label value indicating object image O. Labeled region L12 on composite labeled image S3 is located at the same position as parking space P2 on camera image C1.

Note that labeled regions L11 and L12 may have the same label value, for example. The label value may indicate that no parking is possible.

### [2-2. Operation of Image Generation Device]

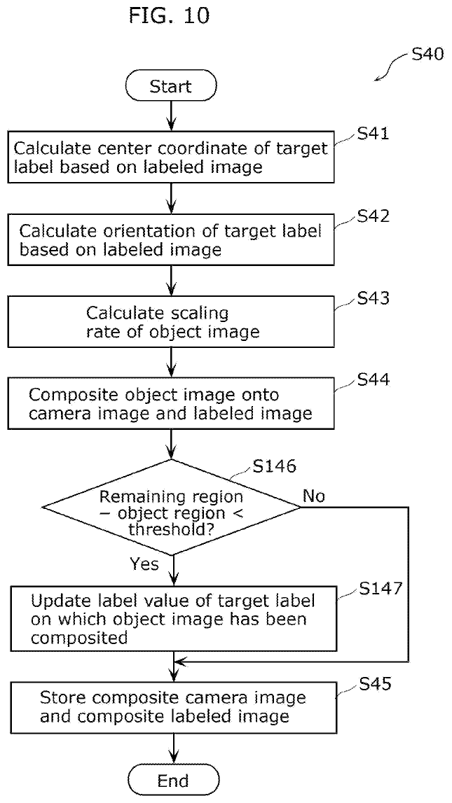

Now, an operation of image generation device 1a according to this embodiment will be described with reference to FIG. 10. FIG. 10 is a flowchart showing the operation in the processing of compositing object image O according to this embodiment. FIG. 10 shows another example of step S40 shown in FIG. 4. Note that the flowchart shown in FIG. 10 corresponds to the flowchart shown in FIG. 5 and further includes steps S146 and S147.

As shown in FIG. 10, label updater 45 determines whether to update the label values of the entire regions with the target labels on labeled image S1. For example, label updater 45 determines whether to update the label values of the entire regions with the target labels based on the following areas. Ones are the areas of the regions (e.g., the labeled regions L1a and L2a shown in FIG. 3B, also referred to as “object regions”) for object image O on the target labels of labeled image S1 on which object image O has been composited. The others are the areas of the rest (e.g., labeled regions L1b and L2b shown in FIG. 3B, also referred to as the “remaining regions”) of the target labels. For example, label updater 45 may make the determination described above based on whether the difference between the areas of each object region and the remaining region is smaller than a threshold parameter (i.e., parameter) (S146). Note that “labeled image S1 onto which object image O has been composited” is labeled image S1 provided with the label value corresponding to object image O. Note that the threshold is set in advance and a positive value, for example, but not limited thereto. The threshold is stored in second storage 50, for example.

If the difference between the areas of the object region and the remaining region is smaller than the threshold (Yes in S146), label updater 45 updates the label value of the target label on which object image O has been composited (S147). For example, label updater 45 updates the label values of labeled regions L1 and L2 on which object image O has been composited in step S44. Composite labeled image S3 (see FIG. 9B) with the updated label values is stored in second storage 50 in step S45.

For example, if the difference between the areas of the object region and the remaining region is larger than or equal to the threshold (No in S146), label updater 45 stores, in second storage 50, labeled image S1 onto which object image O has been composited in step S44. That is, composite labeled image S2 (see FIG. 3B) obtained by compositing object image O in step S44 is stored in second storage 50 in step S45.

As described above, image generation device 1a includes label updater 45 that updates the label values of the target labels on composite labeled image S2 generated by compositor 44. The attributes of the regions with the target labels onto which object image O has been composited are changed by compositing object image O. Accordingly, label updater 45 updates the label values of the regions with the target labels.

If there are a plurality of remaining regions in the region with a target label, label updater 45 may make a determination in step S146, for example, based on the difference between the areas of the object region and the remaining region with the widest area. If no object can be placed in the remaining region with the widest area, the label value of the entire region with the target label including the remaining region can be updated. If there are a plurality of remaining regions in the region with a target label, label updater 45 may make the determination in step S146, for example, based on the difference between the area of the object region and the total area of the remaining regions.

An example has been described above where label updater 45 determines whether to update the label value of the entire region with a target label based on the difference between the areas of the object region and the remaining region. The determination is however not limited thereto. Label updater 45 may determine Yes in step S146, for example, if a label value corresponding to object image O is equal to a predetermined label value, or if the size of the object region of object image O is larger than or equal to a predetermined size. Alternatively, label updater 45 determines whether to update the label value of the entire region with the target label based on the magnitude relationship between the areas of the remaining region and the object region. In this case, label updater 45 may determine Yes in step S146, for example, if the remaining region is smaller than the object region. Label updater 45 may not make the determination in step S146.

### [Other Embodiments]

The training data generation method, for example, according to one or more aspects have been described based on the embodiments. The present disclosure is however not limited to these embodiments. The present disclosure may include other embodiments, such as those obtained by variously modifying the embodiment as conceived by those skilled in the art or those achieved by freely combining the constituent elements in the embodiments without departing from the scope and spirit of the present disclosure.

For example, an example has been described above in the embodiments, for example, where the training data generation method is used to generate training data that allows determination on whether any vehicle is parked in a parking space. The training data generated by the training data generation method is however not limited thereto. For example, the training data generation method may be used to generate training data that allows detection of a region with anyone and a region with no one in a predetermined space (e.g., a room) or may be used to generate any other training data.

While an example has been described above in the embodiments, for example, where each annotated image is a labeled image, the annotated image is not limited thereto. The annotated image may be, for example, a camera image on which the coordinate of a box (e.g., a rectangular box) indicating the position of a predetermined object on the camera image or the box itself is superimposed. The coordinate of the box is an example of annotation information.

In the embodiments, for example, the first and second storages may be included in a single storage device or may be different devices.

An example has been described above in the embodiments, for example, where the combination calculator calculates all the combinations of the labels on a labeled image. The calculation is however not limited thereto. For example, the combination calculator may calculate a preset number of combinations of the labels.

The center coordinates and orientations may be calculated by the position calculator and the orientation calculator, respectively, by any known method other than the calculation method described above in the embodiments.

While an example has been described above in the embodiments, for example, where the image generation device is a single device but may include a plurality of devices. If the image generation device includes a plurality of devices, the constituent elements of the image generation device may be divided into the plurality of devices in any manner.

In the embodiments, for example, at least one of the constituent elements of the image generation device may be a server device. For example, at least one of the processors including the obtainer, the label determiner, and the image compositor may be a server device. If the image generation device includes a plurality of devices including a server device, how the devices of the image generation device communicate with each other is not particularly limited. Wired or wireless communications may be established. Alternatively, wired and wireless communications may be established in combination among the devices.

In the embodiments, for example, at least one of the first and second storages may be a database of an external device (e.g., a server device) of the image generation device. The image generation device may obtain existing training data through communications and output the increased training data through communications.

The training data (e.g., the increased training data) generated in the embodiments described above, for example, may be used to retrain the trained model.

The order of executing the steps in the flowchart is illustrative for specifically describing the present disclosure. The steps may be executed in other orders. Some of the steps may be executed at the same time as (in parallel to) other steps or may not be executed.

The division of the functional blocks in the block diagram is an example. A plurality of functional blocks may be implemented as a single functional block. A single functional block may be divided into a plurality of functional blocks. Some of the functions may be shift to other functional blocks. A plurality of functional blocks with similar functions may be processed in parallel or in a time-shared manner by single hardware or software.

Some or all of the constituent elements of the image generation devices described above may serve as a single system large-scale integrated (LSI) circuit.

The system LSI circuit is a super multifunctional LSI circuit manufactured by integrating a plurality of processors on a single chip, and specifically is a computer system including a microprocessor, a read-only memory (ROM), and a random-access memory (RAM), for example. The ROM stores computer programs. The microprocessor operates in accordance with the computer programs so that the system LSI circuit fulfills its function.

According to an aspect, the present disclosure may be directed to a computer program that causes a computer to execute characteristic steps included in the learning model generation method as shown in FIGS. 4, 5, and 10. For example, the program may be executed by a computer. According to another aspect, the present disclosure may be directed to a non-transitory computer-readable recording medium storing such programs. For example, such programs may be recorded in a recording medium and distributed or circulated. For example, the distributed programs may be installed in a device including another processor and executed by the processor so that the device performs the processing described above.

While various embodiments have been described herein above, it is to be appreciated that various changes in form and detail may be made without departing from the spirit and scope of the present disclosure as presently or hereafter claimed.

Further Information about Technical Background to this Application

The disclosures of the following patent applications including specification, drawings and claims are incorporated herein by reference in their entirety: Japanese Patent Application No. 2020-056123 filed on Mar. 26, 2020 and PCT International Application No. PCT/JP2021/000980 filed on Jan. 14, 2021.

### INDUSTRIAL APPLICABILITY

The present disclosure is useful for an image generation device that generates training data used for machine learning of a learning model.

1. A training data generation method, comprising:
obtaining a camera image, an annotated image generated by adding annotation information to the camera image, and an object image showing an object to be detected by a learning model;
identifying a specific region corresponding to the object based on the annotated image; and
compositing the object image in the specific region on each of the camera image and the annotated image.

2. The training data generation method according to claim 1, further comprising:
calculating a center coordinate of the specific region based on the annotated image, wherein
the object image is composited to overlap the center coordinate on each of the camera image and the annotated image.

3. The training data generation method according to claim 1, further comprising:
calculating an orientation of the specific region based on the annotated image, wherein
the object image is composited in an orientation corresponding to the orientation of the specific region.

4. The training data generation method according to claim 1, further comprising:
obtaining a size of the specific region based on the annotated image, wherein
the object image is scaled to a size smaller than or equal to the size of the specific region, and is composited.

5. The training data generation method according to claim 1, further comprising:
calculating a total number of specific regions corresponding to the object based on the annotated image, the specific regions each being the specific region;
calculating combinations of compositing the object image in one or more of the specific regions; and
compositing the object image in each of the combinations.

6. The training data generation method according to claim 1, further comprising:
updating, based on the object image, the annotation information on the specific region on the annotated image on which the object image has been composited.

7. The training data generation method according to claim 1, wherein
the annotated image is a labeled image obtained by performing image segmentation of the camera image, and
the object image is composited in the specific region on the labeled image.

8. The training data generation method according to claim 1, wherein
the annotated image is a camera image obtained by superimposing a box indicating a position of a predetermined object on the camera image, and
the object image is composited in the specific region on the camera image on which the box has been superimposed.

9. The training data generation method according to claim 1, further comprising:
calculating a coordinate of the specific region based on the annotated image, wherein
the object image is composited to overlap the coordinate on each of the camera image and the annotated image.

10. The training data generation method according to claim 1, further comprising:
determining whether to update the annotation information throughout the specific region on the annotated image on which the object image has been composited in the specific region; and
updating the annotation information on the specific region based on a result of the determining and the object image.

11. The training data generation method according to claim 10, wherein
the determining is performed based on an area of the specific region and an area of the object image.

12. The training data generation method according to claim 10, wherein
the determining is performed based on a first area and a second area, the first area being an area of the object image, the second area being an area of a part of the specific region other than the object image.

13. The training data generation method according to claim 12, further comprising:
determining whether a difference between the first area and the second area is larger than or equal to a threshold; and
updating the annotation information throughout the specific region, if the difference is smaller than the threshold.

14. The training data generation method according to claim 12, further comprising:
determining whether the second area is larger than the first area; and
updating the annotation information throughout the specific region, if the second area is smaller than the first area.

15. The training data generation method according to claim 1, wherein
the object image is generated by cutting a region of the object from an image captured by an imaging device.

16. The training data generation method according to claim 1, wherein
the object image is a computer graphic (CG) image.

17. The training data generation method according to claim 1, wherein
the specific region is a parking space, and
the object image is an image of a vehicle.

18. The training data generation method according to claim 1, wherein
the camera image and the annotated image are obtained from existing training data.

19. A training data generation method, comprising:
obtaining a camera image, an annotated image generated by adding annotation information to the camera image, and an object image showing an object to be detected by a learning model;
identifying a position at which the object is to be composited, based on the annotated image; and
compositing the object image at the position on each of the camera image and the annotated image.

20. A training data generation device, comprising:
an obtainer that obtains a camera image, an annotated image generated by adding annotation information to the camera image, and an object image showing an object to be detected by a learning model;
a label determiner that identifies a specific region corresponding to the object based on the annotated image; and
an image compositor that composites the object image in the specific region on each of the camera image and the annotated image.
